(19) United States
(12) Patent Application Publication
(10) Pub. No.: US 2007/0043874 A1
(43) Pub. Date: Feb. 22, 2007

(54) File transfer method and system

(76) Inventors: Virendra Nath, Honolulu, HI (US); Dan M. Shaw, Honolulu, HI (US)

Correspondence Address: LEIGHTON K. CHONG;GODBEY GRIFFITHS REISS & CHONG, 1001 BISHOP STREET, PAUAHI TOWER SUITE 2300, HONOLULU, HI, 96813, US

(21) Appl. No.: 11/206,345

(22) Filed: Aug. 17, 2005

(51) Int. Cl. G06F 15/16

(52) U.S. Cl. 709/230

(57) ABSTRACT

A file transfer method for transmitting a large data file in slices from a sender to a receiver through the Internet on multiple parallel FTP connections uses the restart (REST) command of the industry-standard FTP Protocol to command an FTP server to transfer the respective slices starting with the first byte corresponding to that slice. This method can obtain the same high speed download performance of multiple simultaneous FTP connections without requiring any special software to be installed at the sender end. The “restart” file transfer method can be employed in a batch-processing system for performing file transfers from multiple FTP servers through the Internet in which each file transfer involves multiple parallel FTP connections. The batch-processing system has designated Receiver Machines for handling file transfers from any FTP server using multiple parallel FTP connections, an Autopoller Server for monitoring the status of file transfers from any FTP server to the Receiver Machines, and an Admin Program connected to the Autopoller Server providing a graphical user interface for an operator for administration of the system.

This invention generally relates to Internet file transfer using the File Transfer Protocol (FTP) for downloads of large files through the Internet, and, more particularly, to an improved method for obtaining very high speeds for large file transfers using multiple parallel download connections, and to a system for batch processing and administration of such large file transfers.

### BACKGROUND OF INVENTION

As shown in FIG. 1, file transfers over the Internet are commonly accomplished by a sender program of one user sending data from an original file over a connection to a receiver program of another user, with the result that the receiver has a copy of the original file. For downloading a file using the File Transfer Protocol (FTP) of the TCP/IP Protocol commonly used on the Internet, as shown in FIG. 2, the sender program is a standard FTP server, the connection is an FTP connection, and the receiver program is a standard FTP client program. The process is initiated by the receiver. All the pieces are widely available and in common use. The method of uploading a file is the reverse of a download, as shown in FIG. 3, with the sender program being a standard FTP client and the receiver being a standard FTP server, and the process is initiated by the sender.

The prior art has shown various methods to improve the speed and functionality of Internet file transfer methods. In U.S. Pat. No. 6,085,251 issued to Fabozzi, multiple separate FTP connections are used to upload a large file initiated by the sender. A control program A on the sender's computer divides the original file into multiple pieces of approximately equal size (packets 1, 2 . . . N) and writes a log file containing the names of the packets and the order in which to reassemble them. The multiple pieces and log file are sent to an FTP server which establishes multiple FTP connections to multiple client computers for uploading the respective pieces of the file. The uploaded pieces and the log file are sent from the multiple FTP clients to the receiver's computer, where a control program B downloads the pieces simultaneously over the multiple FTP connections and reassembles them into a single copy of the original file. The main advantage of this Fabozzi method is a shorter total transfer time due to better utilization of the available bandwidth. The main disadvantage is that special control programs must be installed on the computers at both ends, which requires widespread adoption of the control programs as a standard tool in order for large files to be exchanged among many different users on the Internet.

Another prior art method is shown in U.S. Pat. No. 6,460,087 issued to Saito, in which special sender and receiver programs communicate with each other to send a large file over two FTP connections in parallel. The innovation of Saito over Fabozzi is that the original file is not physically separated into pieces that are reassembled by the receiver. Rather, the sender program sends data over one connection from the beginning of the original file forwards, and sends data over the second connection from the end of the file backwards. Similarly, the receiver writes data from the first connection starting at the beginning of the file copy, and writes data from the second connection in reverse order starting at the end of the file copy. When the two processes meet somewhere near the middle of the file, the file transfer is complete. With the Fabozzi method, it is possible that some packets will finish uploading early, reducing the advantage of simultaneous FTP transmissions. With Saito, both packets finish uploading at the same time, maximizing the advantage of simultaneous transmissions. The Saito method can also be used for more than two simultaneous FTP connections. Once again, the Saito method has the disadvantage that special control programs must be installed on both ends.

Another prior art method is shown in U.S. Patent Application 2003/0088688 of Mori, in which special control programs must be installed at both the sender and receiver ends. Instead of using the industry standard FTP protocol, this method employs a new protocol, called FFTP or Fast File Transfer Protocol, which is implemented on top of the Internet's TCP/IP Protocol. The Mori method also uses multiple simultaneous FTP connections established between the sender and receiver programs. The advantage of this method is that it can be implemented with a single sender program and a receiver program. However, the disadvantage is that nonstandard proprietary programs must be present at both ends.

Yet another prior art method is shown in U.S. Patent Application 2005/0044250 of Gay which is similar to Mori in that special programs are installed at both ends and a special protocol is implemented on top of TCP. Certain differences are provided in the details of the special protocol. Once again, the disadvantage of this approach is that nonstandard proprietary programs must be present at both ends.

### SUMMARY OF INVENTION

It is therefore a principal object of the present invention to overcome the disadvantages of the prior art by providing a file transfer method for large data files that achieves very high transfer speeds by using multiple simultaneous FTP connections but does not require nonstandard proprietary control programs to be present at both the sending and receiving ends of every transmission.

It is a further object of the invention to provide a system for batch processing and administration of such large file transfers from any remote location for high-volume transfers worldwide.

In the present invention, a file transfer method for transmitting a large data file, which contains a series of bytes starting with a first byte nominally numbered as byte 1, from a sender to a receiver through the Internet using an industry-standard File Transfer Protocol (FTP), comprises the steps of:

establishing a plurality of parallel FTP connections through the Internet between an industry-standard FTP server for the sender and a like plurality of intermediary receiving processes 1, 2 . . . N under control of a Control Program; providing instructions from the Control Program to each of the respective intermediary receiving processes 1, 2 . . . N to request transfer of respective slices of the large data file from the FTP server up to a predetermined slice size (SS), wherein intermediary receiving computer 1 requests the transfer of slice 1 starting with a first byte of the data file nominally numbered 1 and finishing with receipt of a last byte nominally numbered SS, and wherein each other intermediary receiving process 2 . . . N requests the transfer of its respective slice N using the REST (restart) command of the industry-standard FTP Protocol to command the FTP server to restart the transfer of slice N starting with a first byte of the data file nominally numbered ((N−1)×SS)+1 and finishing with receipt of a last byte nominally numbered N×SS, or with a last byte of the last slice if the last byte of the large data file is nominally numbered less than N×SS, and

(3) assembling slices 1, 2 . . . N received by the intermediary receiving processes 1, 2 . . . N to form a copy of the original data file for the receiver.

This file transfer method can obtain the same high speed download performance using multiple simultaneous FTP connections as in the prior art, but offers the important additional advantage that no special software is required at the sender end. The file transfer method can be used for downloads to the receiver by configuring the Control Program to control the intermediary receiving processes upon the initiation of a request from the receiver. The intermediary receiving processes can be any computing resources available to the Control Program, such as an array of dedicated computers, or a network or grid of enlisted computers.

In accordance with a further aspect of the present invention, a batch-processing system for performing batch processing using the above-described method of file transfers has:

(a) Receiver Machines, labeled 1 to N, connected to the Internet for handling file transfers from any of a plurality of sender FTP servers using multiple parallel FTP connections through the Internet;

(b) an Autopoller Server coupled to a Database for storing system information which is connected to the Internet for monitoring the status of the multiple file transfers from any of the sender FTP servers to the Receiver Machines; and

(c) an Admin Program connected to the Autopoller Server through the Internet having a graphical user interface for an operator for administration of the system,

wherein each Receiver Machine has a plurality of computing resources each capable of handling an assigned file transfer processes through an associated FTP connection, and

wherein said Autopoller Server is configured to receive a plurality of file transfer requests from subscribers of the system each involving multiple file transfer processes through associated multiple parallel FTP connections, and assigns any of the file transfer processes to any available ones of the computing resources of any of the Receiving Machines and monitors the same.

Other objects, features, and advantages of the present invention will be explained in the following detailed description of the invention having reference to the appended drawings.

### BRIEF DESCRIPTION OF DRAWINGS

FIG. 1 shows the general concept for file transfers over the Internet as known in the prior art.

FIG. 2 shows a standard file transfer uploading method in the prior art.

FIG. 3 shows a standard file transfer downloading method in the prior art.

FIG. 4 shows a file transfer method using multiple simultaneous FTP connections without special software on the sender side in accordance with the present invention.

FIG. 5 shows a file transfer system for batch processing and administration of file transfers using the method of the present invention.

FIG. 6 provides details of the Autopoller Server of the file transfer system for download functions.

FIG. 7 provides details of the Autopoller Server for administrative functions.

FIG. 8 shows a graphical user interface (GUI) for the Admin Program of the system.

FIG. 9 shows a GUI display of Status of file transfer jobs taking place in any channels monitored by the Admin Program.

FIG. 10 shows the status of each receiving Machine handling an active channel and associated processes monitored by the Admin Program.

FIG. 11 shows the status of each process of any active machine monitored by the Admin Program.

FIG. 12 shows comparison results for transfer of a large file using the invention file transfer method.

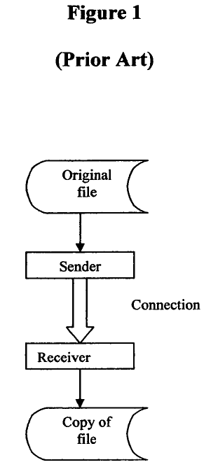

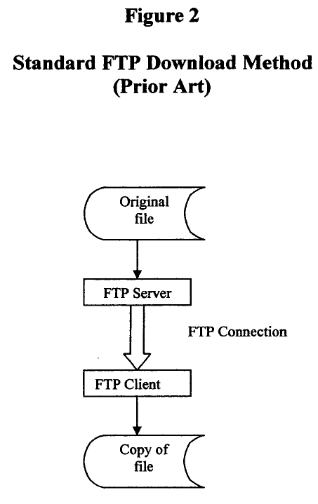

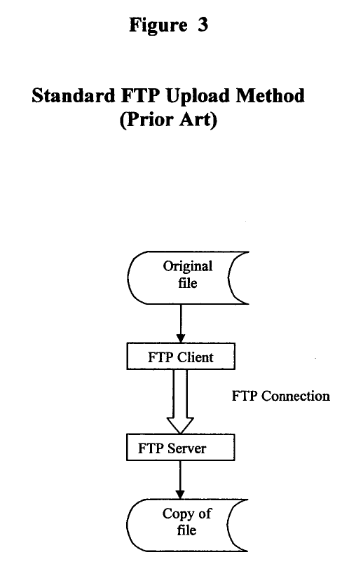

### DETAILED DESCRIPTION OF INVENTION

In the following detailed description of the present invention, a preferred implementation of a file transfer method and preferred embodiment of a file transfer system are described with certain specific details set forth in order to provide a thorough understanding of the present invention. However, it will be recognized by one skilled in the art that the present invention may be practiced without these specific details or with equivalents thereof. In other instances, certain specific components explained herein may be substituted with equivalents that may be well known but have not been described in detail herein as not to unnecessarily obscure aspects of the present invention. It is to be understood that the scope of the invention as disclosed and claimed herein shall not be limited by the specific examples used below to explain certain preferred implementations of the invention.

Some portions of the detailed description of computerized methods below are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “computing” or “translating” or “calculating” or “determining” or “displaying” or “recognizing” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Aspects of the present invention, described below, are discussed in terms of program steps of software executed on a computer system. In general, any type of general purpose, programmable computer system can be used by the present invention. A typical computer system has input and output data connection ports, an address/data bus for transferring data among components, a central processor coupled to the bus for processing program instructions and data, a random access memory for temporarily storing information and instructions for the central processor, a large-scale permanent data storage device such as a magnetic or optical disk drive, a display device for displaying information to the computer user, and one or more input devices such as a keyboard including alphanumeric and function keys for entering information and command selections to the central processor, and one or more peripheral devices such as a mouse. Such general purpose computer systems and their programming with software to perform desired computerized functions are well understood to those skilled in the art, and are not described in further detail herein.

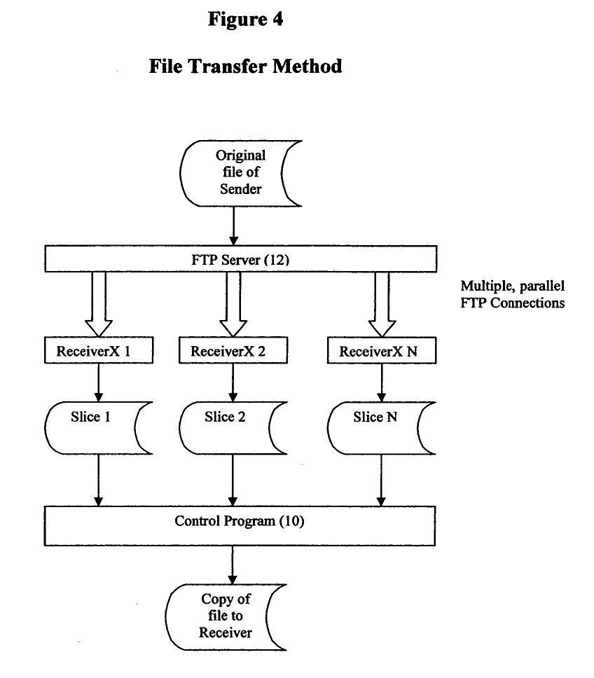

Referring to FIG. 4, a preferred implementation of the file transfer method of the present invention is shown for downloading an original file from a Sender upon a request initiated by a Receiver to a Control Program (10). The download is sent from the Sender's computer through an industry-standard FTP Server on multiple, parallel FTP connections in respective Slices 1 through N of a predetermined slice size (SS), and then reassembled to provide a copy of the original file to the Receiver. The connections are industry-standard FTP connections, and no nonstandard, proprietary control program is required to be present on the Sender's computer or the FTP Server. The multiple parallel downloads in slices is obtained in the invention by having the Control Program (10) employ a plurality of intermediary receiving processes (instances of the same program), called ReceiverX 1, 2, . . . N. The first intermediary receiving process requests transfer of the first slice starting with the first nominally numbered byte and finishing with byte SS, and each other intermediary receiving process requests transfer of its slice from the FTP Server using a standard “restart” command (REST) of the well-known industry-standard FTP Protocol. The REST command in effect “fools” the FTP Server into sending a slice by identifying the “restart” byte as the one nominally numbered as the first byte of the respective slice. The intermediary receiving processes can be any computing resources assigned to the Control Program for file transfers, such as an array of dedicated computers, or a network or grid of enlisted computers.

Almost all modern FTP servers use the industry-standard FTP Protocol which has this REST command, and almost all modern FTP clients can use this REST command to restart aborted downloads. For example, in the standard FTP Protocol, if an FTP client is downloading a file of 10,000,000 bytes and loses the connection after byte 5,000,000, it establishes a new connection, sends a REST 5000001 command and the server will start transmitting at byte 5,000,001. The server, however, does not know whether there was actually an aborted download. It will honor the REST command regardless. This means that the REST command can be used to download part of a file, without having to divide the file into pieces on the server. Thus, in the invention, the Control Program (10) instructs each intermediary ReceiverX other than the first one to request a download of respective slice of the original file using the REST command at a respective starting byte number for that slice. The respective slices are thus downloaded simultaneously to the intermediary ReceiverX 1, 2, . . . N, and reassembled by the Control Program (10) into a copy of the original file for the Receiver.

This file transfer method can be expressed generally as an algorithm comprising the following steps:

(1) establishing a plurality of parallel FTP connections through the Internet between an industry-standard FTP server for the sender and a like plurality of intermediary receiving processes 1, 2 . . . N for a receiver which are under control of a Control Program;

(2) providing instructions from the Control Program to each of the respective intermediary receiving processes 1, 2 . . . N to request transfer of respective slices of the large data file from the FTP server up to a predetermined slice size (SS), wherein intermediary receiving process 1 requests the transfer of slice 1 starting with a first byte of the data file nominally numbered 1 and finishing with receipt of a last byte nominally numbered SS, and

wherein each other intermediary receiving process 2 . . . N requests the transfer of its respective slice N using the REST command of the industry-standard FTP Protocol to command the FTP server to “restart” the transfer of slice N starting with a first byte of the data file nominally numbered ((N−1)×SS)+1 and finishing with receipt of a last byte nominally numbered N×SS, or with a last byte of the last slice if the last byte of the large data file is nominally numbered less than N×SS, and

(3) assembling slices 1, 2 . . . N received by the intermediary receiving processes 1, 2 . . . N to form a copy of the original data file for the receiver.

The above-described file transfer method can thus obtain a comparable high speed download performance for large files using multiple simultaneous FTP connections as in the prior art, but offers the important additional advantage that no special software is required at the sender end. A user of this file transfer method can therefore implement everything needed for high performance file transfers without needing to deploy or distribute special software widely among users. In fact, the FTP Servers do not even have to recognize that the file transfer jobs are being performed with a special Control Program at the receiver end. A specific illustrative example of the execution of this method is provided below.

Example: File Transfer Method

The Receiver Control Program (10) is tasked to download file ABC.zip from a Sender through a standard FTP Server (12). For this example, assume that the Control Program has been set or has determined (through analysis of Internet traffic and bandwidth availability conditions) that the download will be performed with minimum slice sizes of 5,000,000 bytes and that the bytes of the download file ABC.zip are numbered starting from 1.

Step 1

The Control Program establishes an FTP connection with the FTP Server and sends a SIZE command, which is a standard command in the FTP Protocol. The Server responds that file ABC.zip is 15,000,000 bytes long.

Step 2

The Control Program divides the determined minimnum slice size of 5,000,000 bytes into the total file size of 15,000,000 bytes, and determines that 3 simultaneous download connections are needed, and instructs 3 intermediary ReceiverX 1, 2, 3 to start downloading simultaneously.

Step 3a

ReceiverX 1 is instructed by the Control Program to establish a standard FTP connection with the FTP Server, and sends a standard RETR (retrieve) command to the Server to start downloading data from the file ABC.zip beginning at the starting byte 1. When it has received up to byte 5,000,000, ReceiverX 1 stops, as it has received a complete Slice 1, and notifies the Control Program that it is finished.

Step 3b

ReceiverX 2 is instructed by the Control Program to establish a second FTP connection with the Server and sends a REST 5000001 (restart at byte 5,000,001) command to the Server. The Server sets a byte counter to 5,000,001 for the download to ReceiverX 2, as if ReceiverX 2 were restarting an aborted download. ReceiverX 2 then sends a RETR command to the Server and starts downloading data from the file ABC.zip beginning at the starting byte 5,000,001, which it begins storing as file Slice 2. When ReceiverX 2 has received the determined slice size of 5,000,000 bytes, corresponding to byte 10,000,000 in the original file, it stops and notifies the Control Program.

Step 3c

ReceiverX 3 is instructed by the Control Program to establish a third FTP connection with the Server and send a REST 10000001 (restart at byte 10,000,001) command to the Server. The Server sets a byte counter to 10,000,001 for the download to ReceiverX 3. ReceiverX 3 then sends a RETR command to the Server and starts downloading data from the file ABC.zip beginning at the starting byte 10,000,001, which it begins storing as file Slice 3. When ReceiverX 3 has received the determined slice size of 5,000,000 bytes, corresponding to byte 15,000,000 in the original file, it stops and notifies the Control Program.

Step 4

When all 3 intermediary Receivers have finished their respective downloads, the Control Program assembles the downloaded files Slice 1, Slice 2 and Slice 3 into a complete copy of the original file ABC.zip.

In this manner, the Control Program can obtain the high speed performance on multiple simultaneous FTP connections using the standard commands of the FTP Protocol without any special software required at the sender end. The Control Program does not have to be on the same machine as the intermediary receiver resources. The intermediary receiver resources do not have to be processes running on the same machine, but processes running on different machines enlisted on an external network. The intermediary receiver resources can also be tasked for different download jobs and do not need to be connected to the same FTP server each time.

The Control Program is described as performing downloads initiated by a request from the receiver for a file from a sender. The FTP REST command is not symmetric with respect to downloads and uploads. The REST (restart) command applies only to downloads. There is a different mechanism for restarting uploads, but it does not work for multiple connections.

The flexibility of the file transfer method and avoidance of users needing to have any special FTP software allows the invention method to be used in a file transfer system that can handle file transfer jobs in batch processing mode from anywhere in the world. Such as batch-processing file transfer system will now be described.

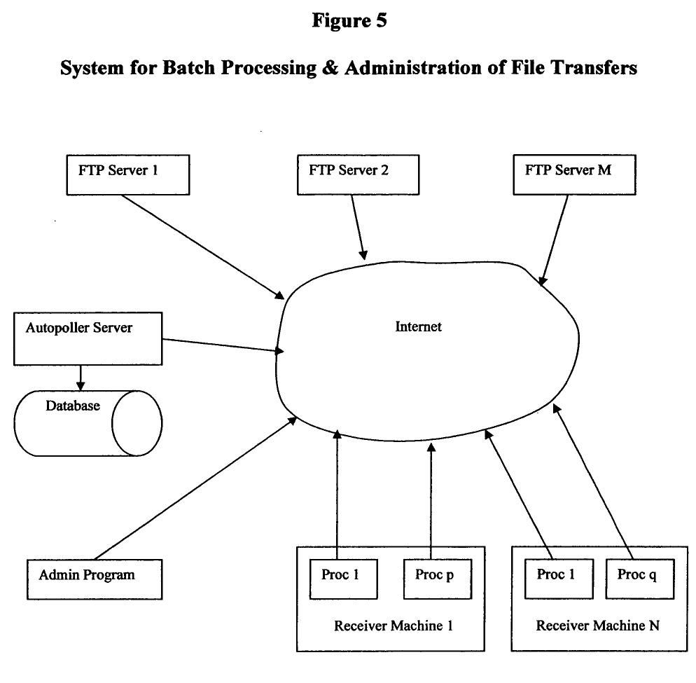

Referring to FIG. 5, a preferred embodiment of a batch processing system for performing file transfers from multiple FTP servers through the Internet, using the invention method in which each file transfer involves multiple parallel FTP connections, employs designated Receiver Machines, labeled 1 to N, connectable to any of the FTP Servers 1 . . . M through the Internet. Each Receiver Machine can have an array of computing resources or parallel processors that can handle multiple file transfer processes, labeled respectively as Proc 1 to p, Proc 1 to q, etc. An Autopoller Server is coupled to a Database and connected through the Internet to monitor the status of multiple file transfer jobs between FTP Servers and Receiver Machines. An Admin Program is connected to the Autopoller Server through the Internet and provides a graphical user interface (GUI) for an operator for administration of the system. The Autopoller Server is configured to receive file transfer requests from subscribers of the system involving multiple file transfer processes through parallel FTP connections, and assigns any of the file transfer processes to any available ones of the computing resources of any of the Receiving Machines. The FTP Servers can be located in one geographic region such as the U.S. Mainland, the Receiver Machines can be located in a destination geographic region such as Asia, the Autopoller Server can be located in a centralized geographic location such as Honolulu, and the Admin Program can be operated from any location. The operation of the components of the system is as follows.

Autopoller Server

The Autopoller Server listens for requests for tasks to be performed by Processes on the Receiver Machines, and sends commands to them to complete their process or assigns them a new one. Firewalls typically allow outgoing connections but block incoming connections. The Autopoller Server is the only component in the system that allows incoming connections, so all firewall configuration issues can be resolved at the Autopoller Server. It also stores process information into the Database or updates process information from the Database. Typical requests from Processes are:

Give me something to do.

Here is a list of files; give me something to do.

I just downloaded a file slice; give me something else to do.

I just copied several file slices into a complete file; give me something to do.

Here is an error code; give me something to do.

The Autopoller Server processes the requests from the Processes, updates the Database and issues commands. Typical commands are:

Go to FTP Server M and list the directory.

Download slice 3 of file ABC.zip on FTP server M.

Assemble slices 1, 2 and 3 into a copy of ABC.zip.

Sleep for a few minutes and check in again.

Admin Program

The Admin Program is used to process file transfer job requests from subscribers or client sites, and send appropriate instructions to the Autopoller Server and the FTP Servers sending the download files for the efficient performance of these download jobs. It does this by sending data to the Autopoller Server or retrieving data from the Autopoller Server to enable respective file transfer jobs to be performed between a designated FTP Server and a Process on any available computing resource monitored by the Autopoller Server. For example, it can send messages as:

Customer M has an FTP Server site at IP number 12.34.56.78.

The login is ftp and the password is demo.

Starting at 11 pm, download all files matching *.zip and save them in directory XYZ.

The Admin Program can also be used to monitor the status of the download jobs as monitored by the Autopoller Server or print a report of download activity. The Admin Program can be run from any location as long as it has a connection to the Autopoller Server which in turn is connected to the sender sites and the receiver machine processes anywhere.

Receiver Machine Processes

Each Receiver Machine Process connects to the Autopoller Server and requests or reports on a file transfer task. Typical tasks it may be requested to do are:

Go to FTP server M and list the directory for all files matching *.zip

Download slice 3 of file ABC.zip on FTP Server M.

Assemble Slices 1, 2 and 3 into a copy of ABC.zip.

Sleep for a few minutes and check in again.

The Process performs the task it is given and sends a completion message if successful, or an error code if unsuccessful. Whenever it reports completion to the Autopoller Server, it may be given a new task.

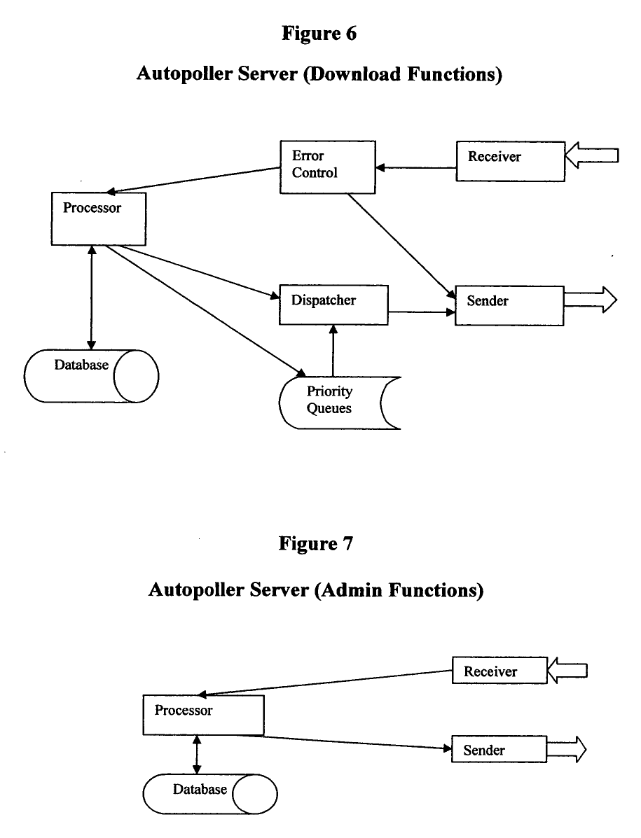

Referring to FIG. 6, a typical operation of the Autopoller Server for downloading functions may involve the following component functions. The Receiver function of the Autopoller Server waits for a message from a client Process. The message may report on the results of the Process' performance of the last command. The Error Control compares the serial number of the message with the serial number of the last command issued to that Process. If the serial numbers are different, then this is a duplicate message and the Error Control resends the last command. If the serial numbers are the same, it hands the message to its Processor. The Processor processes the results of the last command and updates the Database and possibly adds commands to the priority queues. For example, if the last command was “list directory”, there may be new files to download. The Processor then transfers the information to the Dispatcher. The Dispatcher selects the next command from the priority queues and hands it to its Sender. The Sender sends the next command to the respective client Process. The Priority Queues are lists of commands to be performed. Each command has a priority. When a command is inserted into a priority queue, it takes its place in line according to its priority. Commands are taken out of a priority queue in order of priority (highest priority first).

Referring to FIG. 7, a typical operation of the Autopoller Server for administrative functions may involve the following component functions. The Receiver waits for a file transfer job request from the Admin Program. The Processor processes the request, placing information into the Database and/or extracting information from the database. The Sender sends the results of the request to the Admin Program.

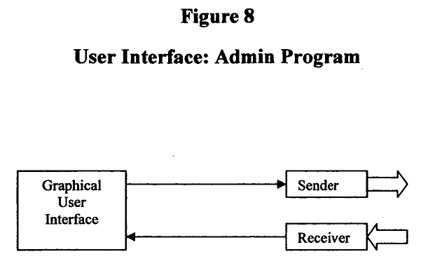

Referring to FIG. 8, the component functions of the Admin Program are as follows. The Graphical User Interface acts as a graphical front-end for accessing and updating information on file transfer jobs in the Database of the Autopoller Server. The Admin Program has no database of its own. When the operator performs actions in the Admin Program (clicking command buttons, for example), the Admin Program sends a request to the Autopoller server and waits for a response. When the response arrives, the Admin Program updates the GUI display. The Sender sends requests to the Autopoller Server. Requests may involve storing information into the Database (for example, “save these job settings”) or retrieving information from the Database (for example, “get a list of jobs for this FTP site”). The Receiver waits for a response from the Autopoller Server and hands it to the Graphical User Interface. The Admin Program is thus a front-end control program that has a small footprint and can be transported and operated from any location or even on small or mobile computing devices.

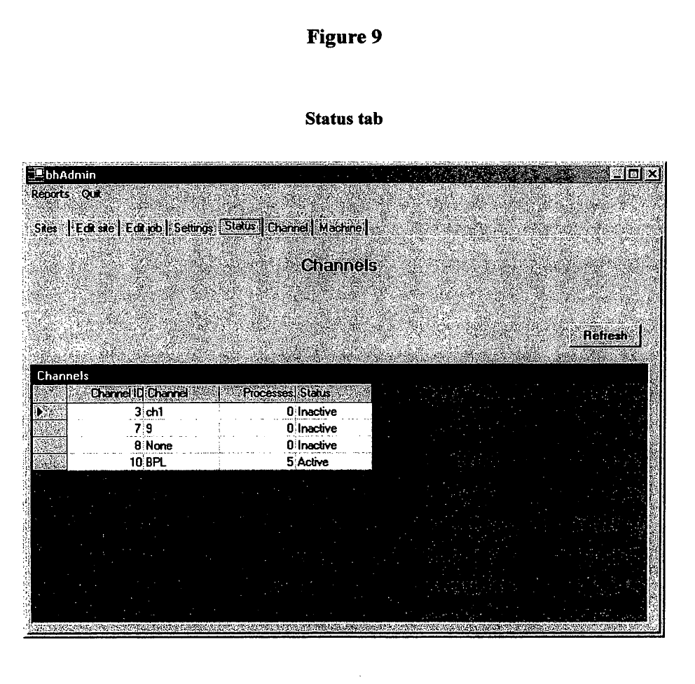

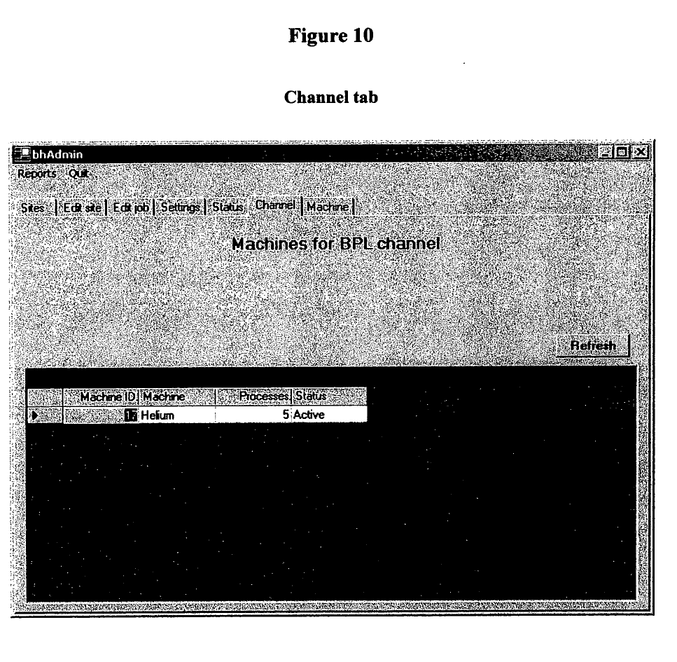

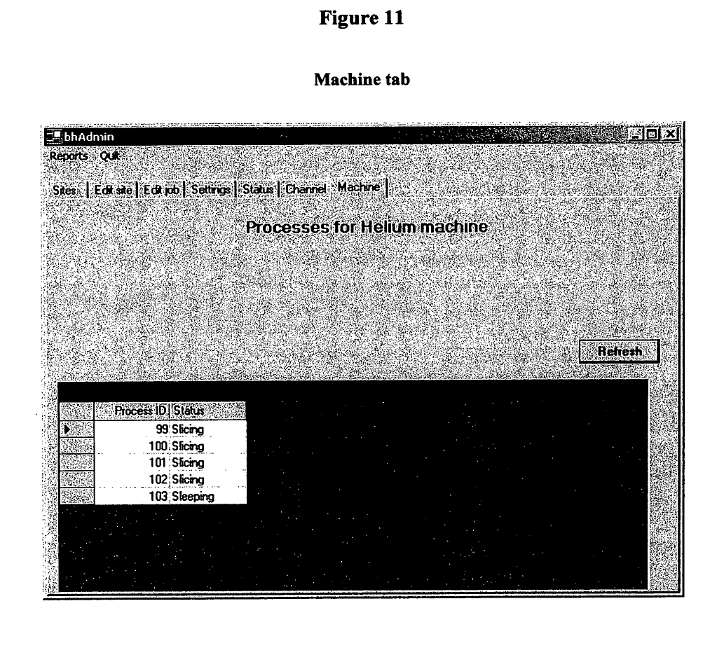

As an example of the Graphical User Interface of the Admin Program, FIG. 9 shows a functional display of Status of file transfer jobs taking place in any channels (client download request from FTP server site to receiver site) and associated processes being monitored by the Admin Program, FIG. 10 shows the status of each receiving Machine handling an active channel (here, the BPL Channel) and associated processes, and FIG. 11 shows the status of each process of any active machine (here, the Helium Machine).

The Control Program may be configured to apply a predetermined fixed slice size, such as 5,000,000 bytes, in setting up the multiple, parallel download processes, based on a prior determination of an optimal slice size to use for expected average Internet traffic and bandwidth availability conditions. Alternatively, the Control Program can dynamically adjust the slice size based on current Internet data indicating current Internet traffic and bandwidth availability conditions. Even further, for a file transfer system implemented by a service agency that will handle large batch processing of file transfer jobs from clients in different geographic regions having different Internet traffic and bandwidth availability conditions, the Control Program can dynamically adjust the slice size for each file transfer job based on current Internet data indicating current Internet traffic and bandwidth availability conditions for the transfer route from the sending FTP server to the receiving machine(s) for that job.

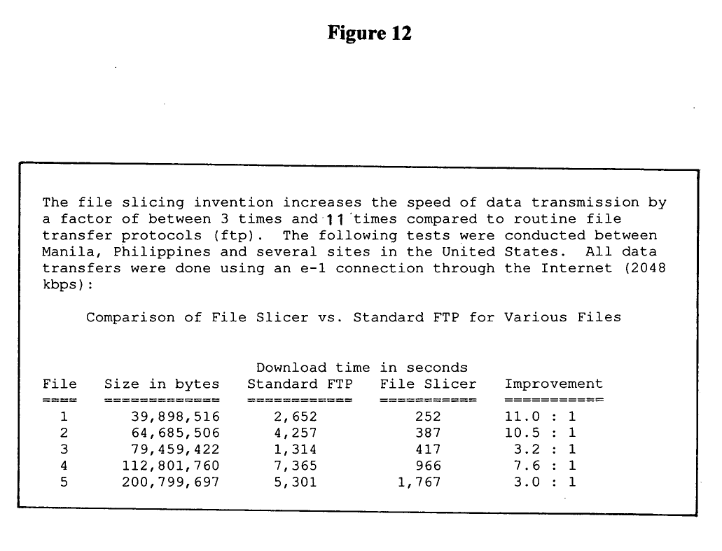

By applying the multiple parallel FTP connections to transmit slices of a large data file in slices simultaneously, the file transfer method of the present invention can achieve the high transfer speed levels of prior art methods that use multiple parallel FTP connections, but by using the standard REST command of common the FTP Protocol avoids the need to have nonstandard proprietary software installed on the sending side (for downloads) or the receiving for uploads. A printout of comparison results for transfer of a large file is shown in FIG. 12, confirming that speed gains of 10-fold or more were obtained on a test file transfer from the U.S. Mainland to Asia.

For a more detailed understanding of the logic sequence used in the preferred implementation of the file transfer method described above, a sample source code listing for the function of dividing a file into slices is provided in Appendix I, and a sample source code listing for the function of downloading one file slice is provided in Appendix II. Further, a sample source code listing for the Autopoller Server function in which the Dispatcher selects the next command from the priority queues and hands it to its Sender is provided in Appendix III. The coding for these functions is intended only to be illustrative of an approach to code implementation of these functions and it is expected that these functions may readily be coded in other equivalent ways.

It is understood that many modifications and variations may be devised given the above description of the principles of the invention. It is intended that all such modifications and variations be considered as within the spirit and scope of this invention, as defined in the following claims.

1. A file transfer method for transmitting a large data file, containing a series of bytes starting with a first byte nominally numbered as byte 1, from a sender to a receiver through the Internet using an industry-standard File Transfer Protocol (FTP), comprising the steps of:
establishing a plurality of parallel FTP connections through the Internet between an industry-standard FTP server for the sender and a like plurality of intermediary receiving processes 1, 2 . . . N under control of a Control Program;
providing instructions from the Control Program to each of the respective intermediary receiving processes 1, 2 . . . N to request transfer of respective slices of the large data file from the FTP server, each slice being up to a predetermined slice size (SS),
wherein intermediary receiving process 1 requests the transfer of slice 1 starting with a first byte of the data file nominally numbered 1 and finishing with receipt of a last byte nominally numbered SS, and
wherein each other intermediary receiving process 2 . . . N requests the transfer of its respective slice N using the REST (restart) command of the industry-standard FTP Protocol to command the FTP server to restart the transfer of slice N starting with a first byte of the data file nominally numbered ((N−1)×SS)+1 and finishing with receipt of a last byte nominally numbered N×SS, or with a last byte of the last slice if the last byte of the large data file is nominally numbered less than N×SS, and
(3) assembling slices 1, 2 . . . N received by the intermediary receiving processes 1, 2 . . . N to form a copy of the original data file for the receiver.

2. A file transfer method according to claim 1, wherein the Control Program obtains high speed performance of each file transfer performed on multiple simultaneous FTP connections without any special software required at the sender end.

3. A file transfer method according to claim 1, wherein the Control Program is configured to perform downloads initiated by a request from intermediary receiving processes for the receiver to the FTP server for the sender.

4. A file transfer method according to claim 3, wherein no special file transfer program is required on the FTP server for the sender, and the FTP server does not need to recognize any special transfer program for the receiver.

5. A file transfer method according to claim 1, wherein the Control Program controls the intermediary receiving processes in an array of dedicated computers.

6. A file transfer method according to claim 1, wherein the Control Program controls the intermediary receiving processes as computing resources enlisted on a network or grid of computers.

7. A file transfer method according to claim 1, wherein the Control Program is configured to apply a predetermined fixed slice size.

8. A file transfer method according to claim 1, wherein the Control Program is configured to dynamically adjust the slice size based on current Internet traffic and bandwidth availability conditions.

9. A file transfer method according to claim 1, wherein the Control Program is configured to dynamically adjust the slice size for each file transfer job based on current Internet traffic and bandwidth availability conditions.

10. A file transfer method for transmitting a large data file in slices from a sender to a receiver through the Internet using an industry-standard File Transfer Protocol (FTP), said method proceeding by establishing a plurality of parallel FTP connections through the Internet between an industry-standard FTP server for the sender and a like plurality of intermediary receiving processes for receiving respective slices of the data file from the FTP server, and each of the intermediary receiving processes 2 . . . N requests the transfer of a respective slice using the REST (restart) command of the industry-standard FTP Protocol to command the FTP server to restart the transfer of that slice from a first byte of the data file corresponding to a first byte for that slice.

11. A batch-processing system employing the method of claim 10 for performing file transfers from multiple FTP servers through the Internet in which each file transfer involves multiple parallel FTP connections, said system comprising:
(a) Receiver Machines 1 to N connected to the Internet for handling file transfers from any FTP server using multiple parallel FTP connections through the Internet;
(b) an Autopoller Server coupled to a Database for storing system information which is connected to the Internet for monitoring the status of the file transfers from any of the FTP servers to the Receiver Machines; and
(c) an Admin Program connected to the Autopoller Server through the Internet having a graphical user interface for an operator for administration of the system,
wherein each Receiver Machine has a plurality of computing resources each capable of handling an assigned file transfer processes through an associated FTP connection, and
wherein said Autopoller Server is configured to receive a plurality of file transfer requests from subscribers of the system each involving multiple file transfer processes through associated multiple parallel FTP connections, and assigns any of the file transfer processes to any available ones of the computing resources of any of the Receiving Machines and monitors the same.

12. A batch-processing system according to claim 11, wherein the plurality of parallel FTP connections are established by the respective computing resources under control of a Control Program to request transfer of respective slices of a data file in a file transfer, and the computing resources request the transfer of respective slices using the REST command of the industry-standard FTP Protocol to command the FTP server to restart the transfer of that slice from a first byte of the data file corresponding to a first byte for that slice from the FTP server.

13. A batch-processing system according to claim 12, wherein the Control Program obtains high speed performance of each file transfer performed on multiple simultaneous FTP connections without any special software required on an FTP server for a sender.

14. A batch-processing system according to claim 12, wherein the Control Program is configured to perform downloads initiated by a request from intermediary receiving processes for the receiver to the FTP server for the sender.

15. A batch-processing system according to claim 14, wherein no special file transfer program is required on the FTP server for the sender, and the FTP server does not need to recognize any special transfer program for the receiver.

16. A batch-processing system according to claim 12, wherein the Control Program controls the intermediary receiving processes in an array of dedicated computers.

17. A batch-processing system according to claim 12, wherein the Control Program controls the intermediary receiving processes as computing resources enlisted on a network or grid of computers.

18. A batch-processing system according to claim 12, wherein the Control Program is configured to apply a predetermined fixed slice size.

19. A batch-processing system according to claim 12, wherein the Control Program is configured to dynamically adjust the slice size based on current Internet traffic and bandwidth availability conditions.

20. A batch-processing system according to claim 12, wherein the Control Program is configured to dynamically adjust the slice size for each file transfer job based on current Internet traffic and bandwidth availability conditions.
